(19) United States
(12) Patent Application Publication
(10) Pub. No.: US 2022/0245485 A1
(43) Pub. Date: Aug. 4, 2022

(54) MULTI-MODEL BLOCK CAPACITY FORECASTING FOR A DISTRIBUTED STORAGE SYSTEM

(71) Applicant: NetApp, Inc., Sunnyvale, CA (US)

(72) Inventor: Tyler W. Cady, Boulder, CO (US)

(21) Appl. No.: 17/167,445

(22) Filed: Feb. 4, 2021

(51) Int. Cl. G06N 5/04; G06N 20/00; G06F 16/182; G06F 17/18

(52) U.S. Cl. CPC G06N 5/04; G06F 17/18; G06F 16/1824; G06N 20/00

(57) ABSTRACT

Systems and methods for use a multi-model block capacity forecasting approach are provided to predict when a distributed storage system will reach a fullness threshold. According to one embodiment, given a time series telemetry dataset collected from multiple distributed storage systems, a forecasting algorithm trains multiple time series forecasting models (e.g., Simple linear regression (SLR), Autoregressive Integrated Moving Average (ARIMA), Generalized additive model (GAM), and/or others) for each of the distributed storage systems. The best performing time series forecasting model is then independently selected for each of the distributed storage systems based on a respective performance metric (e.g., root mean squared error) associated with the time series forecasting models. Forecasted data points for each distributed storage system and the corresponding future time frames in which one or more predetermined or configurable block capacity fullness thresholds are predicted to be crossed may be determined based on the selected time series forecasting models.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright 2021, NetApp, Inc.

### BACKGROUND

### Field

Various embodiments of the present disclosure generally relate to data analytics, data science, and machine learning techniques and their application to forecasting of the performance of a distributed system and/or consumption trends of a resource of the distributed storage system. In particular, some embodiments relate to training of multiple machine-learning (ML) models based on time series data, including information regarding consumed block capacity, gathered from a distributed storage system and forecasting based on a selected (ML) model an amount of time until the consumed block capacity will reach a threshold.

### Description of the Related Art

Forecasting of metrics associated with performance of a distributed storage system based on historical data is a complex task. Block capacity fullness of a distributed storage system is a non-limiting example of a particular metric relating to performance of a distributed storage system. The accuracy of a forecast relating to when a distributed storage system will reach a particular fullness threshold, for example, indicative of when the distributed storage system will run out of storage space can have significant consequences. For example, inaccuracies of the forecasting technique employed may result in under-capacity incidents and potential disruption of business operations due to insufficient storage. Meanwhile, it is also desirable to avoid over-capacity incidents, which represent an inefficient use of business assets.

### SUMMARY

Systems and methods are described for the use a multi-model block capacity forecasting approach to predict when a distributed storage system will reach a fullness threshold. According to one embodiment, a set of time series telemetry data records are collected from multiple distributed storage systems. Each time series telemetry data record of the set of time series telemetry data records includes a timestamp and information regarding a consumed block capacity. The time series telemetry data records are split into a training dataset and a testing dataset. For each distributed storage system: (i) a subset of the training dataset and a subset of the testing dataset is created for the distributed storage system; (ii) multiple machine-learning models are trained based on the subset of the training dataset; (iii) a trained machine-learning model is selected based on respective performance metrics determined for the trained machine-learning models by cross-validating the trained machine-learning models using the subset of the testing dataset; and (iv) an amount of time until a consumed block capacity threshold will be reached is then forecasted by the distributed storage system based on the selected trained machine-learning model.

Other features of embodiments of the present disclosure will be apparent from accompanying drawings and detailed description that follows.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 is a block diagram illustrating an environment in which various embodiments may be implemented.

FIG. 2 is a block diagram illustrating a storage node in accordance with an embodiment of the present disclosure.

FIG. 3 is a flow diagram illustrating a set of operations for telemetry data monitoring processing in accordance with an embodiment of the present disclosure.

FIG. 4 is a bar chart illustrating used block capacity over time for a distributed storage system.

FIG. 5 is a flow diagram illustrating a set of operations for training and forecasting processing in accordance with an embodiment of the present disclosure.

FIG. 6 illustrates an example computer system in which or with which embodiments of the present disclosure may be utilized.

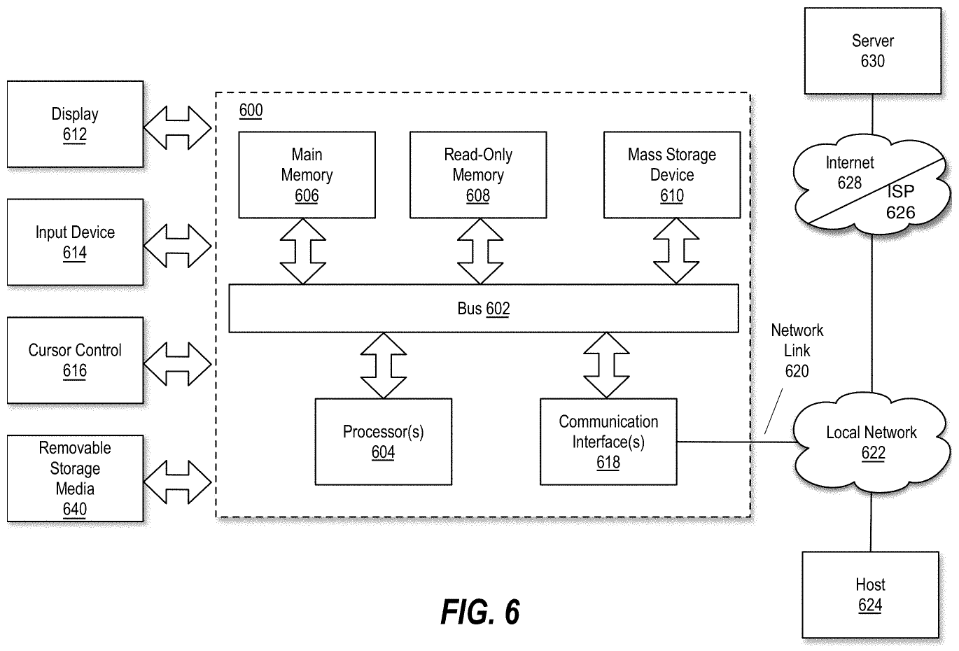

### DETAILED DESCRIPTION

Systems and methods are described for the use a multi-model block capacity forecasting approach to predict when a distributed storage system will reach a fullness threshold. The accuracy of a forecast relating to when a distributed storage system will reach a particular fullness threshold, (e.g., indicative of when the distributed storage system will run out of storage space) can have significant consequences. For example, inaccuracies of the forecasting technique employed may result in under-capacity incidents and potential disruption of business operations due to insufficient storage.

Accurately forecasting a block capacity fullness threshold for a single distributed storage system is a challenge, let alone doing so across a field of distributed storage systems (e.g., those monitored on behalf of an entire customer base or a subset thereof). The typical trend one finds through preliminary data analysis is that block capacity consumption generally follows a linear/near-linear model. Notably, however, there may be in fact large subsets of the field whose block capacity trends do not fit a linear trend due to non-linear seasonal/business usage patterns (e.g., a storage intensive task that is performed bi-weekly, monthly, quarterly, or annually, such as payroll, tax reporting or the like). As such, existing simplistic linear models used for capacity planning are likely to provide inaccurate and/or misleading block capacity fullness threshold forecasts and the inaccuracy is exacerbated the further into the future one looks.

Embodiments described herein seek to provide more accurate forecasts relating to when a consumed block capacity of a distributed storage system will reach one or more thresholds (e.g., warning, error, or critical). Various embodiments of the present technology provide for a wide range of technical effects, advantages, and/or improvements to computing systems and components. For example, various embodiments may include one or more of the following technical effects, advantages, and/or improvements: (i) integrated collection and dynamic monitoring of one or more of a field of distributed storage systems to efficiently collect time series telemetry data; and (ii) use of non-routine and unconventional computer operations to enhance the accuracy of forecasting, for example, using a unique best-model-candidate selection approach to account for and forecast various linear and non-linear trends in block capacity usage for individual distributed storage systems of a group of monitored distributed storage systems.

According to one embodiment, a multi-model block capacity forecasting approach is provided to predict when a distributed storage system will reach a fullness threshold. Given a time series telemetry dataset collected from multiple distributed storage systems, a forecasting algorithm may train multiple time series forecasting models for each of the individual distributed storage systems. For example, time series telemetry data records, each including a timestamp and information regarding a consumed block capacity, may be periodically collected from multiple distributed storage systems.

The collected time series telemetry data records can be split into a training dataset and a testing dataset. As those skilled in the art appreciate, the training dataset represents the actual dataset that is used to train a machine-learning model, whereas the testing dataset represents a sample of data that facilitates evaluation of a final model fit on the training dataset. After splitting the collected time series telemetry data records into the training dataset and the testing data set, for each distributed storage system, training processing may be performed, including: (i) creating a subset of the training dataset and a subset of the testing dataset; and (ii) training the multiple time series forecasting models based on the subset of the training dataset. The best performing time series forecasting model may be then independently selected for each of the multiple distributed storage systems based on performance metrics associated with the time series forecasting models. For example, as described further below, one of the trained machine-learning models may be selected based on their respective performance metrics (e.g., root mean squared error) determined by cross-validating based on the subset of the testing dataset.

Based on the respective selected time series forecasting models for each distributed storage system, forecasted data points may be determined and timing information (e.g., an amount of time or number of days until, a time or date range, or a particular date) indicative of when the one or more predetermined or configurable block capacity fullness thresholds are predicted to be crossed may be determined for each distributed storage system. For example, the dates (on which one or more consumed block capacity thresholds of various levels of severity (e.g., warning, error, or critical) will be reached by each individual distributed storage system may be determined based on the time series forecasting model that is deemed to be most accurate for the block capacity usage trends of the distributed storage system at issue. Alternatively or additionally, an amount of time until one or more predetermined or configurable block capacity fullness thresholds or a window of time (e.g., a date range or a time range) during which such thresholds are predicted to be crossed may be determined based on a predetermined or configurable confidence level. This information (and/or associated alerts, warnings or notification relating) may then be conveyed to appropriate stakeholders (e.g., an administrative user for a particular distributed storage system or group of distributed storage systems). Advantageously, having an accurate estimate regarding the timing of various capacity fullness thresholds may provide the administrator with an opportunity to take appropriate action (e.g., adding additional storage nodes to a particular distributed storage system to address a predicted under-capacity situation in the future or reconfiguring an association of one or more existing storage nodes with one distributed storage system to another to address an existing over-capacity situation). In some embodiments, such addition and/or reconfiguration of storage nodes may be automated and triggered responsive to the forecasts.

While embodiments of the present disclosure are described herein with reference to forecasting block capacity fullness thresholds for one or more distributed storage systems, embodiments of the present disclosure are applicable to forecasting relating to other performance metrics, including but not limited to metadata capacity.

In the following description, numerous specific details are set forth in order to provide a thorough understanding of embodiments of the present disclosure. It will be apparent, however, to one skilled in the art that embodiments of the present disclosure may be practiced without some of these specific details. In other instances, well-known structures and devices are shown in block diagram form.

### Terminology

Brief definitions of terms used throughout this application are given below.

A “computer” or “computer system” may be one or more physical computers, virtual computers, or computing devices. As an example, a computer may be one or more server computers, cloud-based computers, cloud-based cluster of computers, virtual machine instances or virtual machine computing elements such as virtual processors, storage and memory, data centers, storage devices, desktop computers, laptop computers, mobile devices, or any other special-purpose computing devices. Any reference to “a computer” or “a computer system” herein may mean one or more computers, unless expressly stated otherwise.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure, and may be included in more than one embodiment of the present disclosure. Importantly, such phrases do not necessarily refer to the same embodiment.

### Example Operating Environment

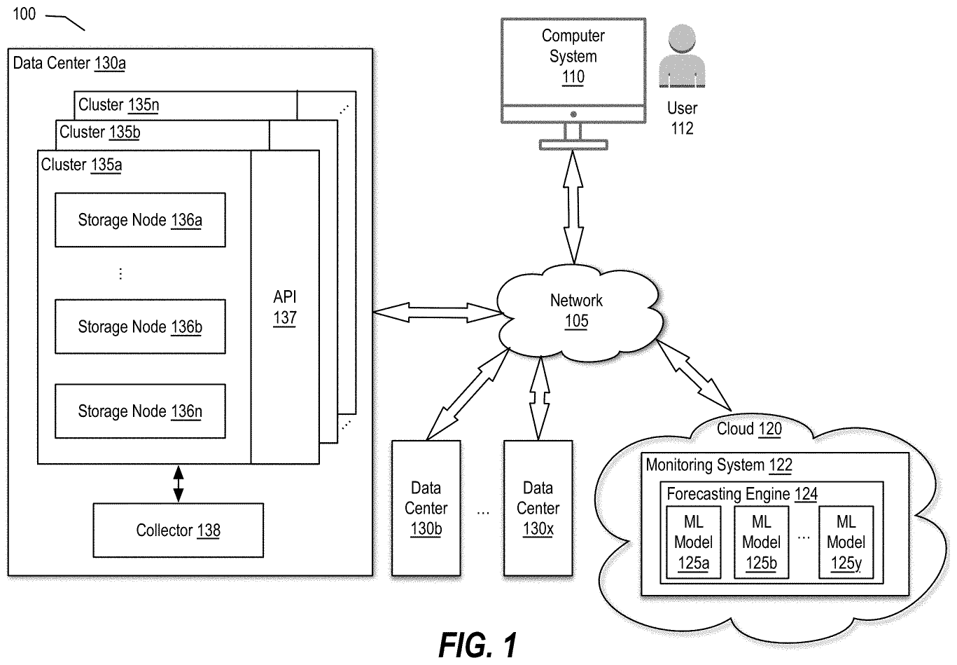

FIG. 1 is a block diagram illustrating an environment 100 in which various embodiments may be implemented. In various examples described herein, an administrator (e.g., user 112) of a distributed storage system (e.g., cluster 135a) or a managed service provider responsible for multiple distributed storage systems (e.g., clusters 135a-n) of the same or multiple customers may monitor various telemetry data of the distributed storage system or multiple distributed storage systems via a browser-based interface presented on computer system 110. In one embodiment, notifications, alerts, warnings, error messages may be logged, presented to the administrator via the browser-based interface, or otherwise brought to the attention of the administrator (e.g., via email, text message, or the like) based on a forecast regarding a performance metric being predicted to meet or exceed one or more predefined or configurable thresholds within corresponding predefined or configurable timeframes. For example, as described further below, responsive to a time series forecasting model indicating a consumed block capacity of a particular distributed storage device is expected to meet or exceed a particular block capacity fullness threshold, the administrator may be alerted to provide the administrator with suitable time to add a new storage node to the cluster at issue.

In the context of the present example, the environment 100 includes multiple data centers 130a-x, a cloud 120, a computer system 110, and a user 112. The data centers 130, the cloud 120, and the computer system 110 are coupled in communication via a network 105, which, depending upon the particular implementation, may be a Local Area Network (LAN), a Wide Area Network (WAN), or the Internet.

The data centers 130 may represent enterprise data centers (e.g., on-premises customer data centers) that are build, owned, and operated by a company or the data centers 130 may be managed by a third party (or a managed service provider) on behalf of the company, which may lease the equipment and infrastructure. Alternatively, the data centers 130 may represent colocation data centers in which a company rents space of a facility owned by others and located off the company premises. Data center 130a is shown including multiple distributed storage systems (e.g., clusters 135a-n) and a collector 138. Those of ordinary skill in the art will appreciate additional IT infrastructure may be part of the data center 130a; however, discussion of such additional IT infrastructure is unnecessary to the understanding of the various embodiments described herein.

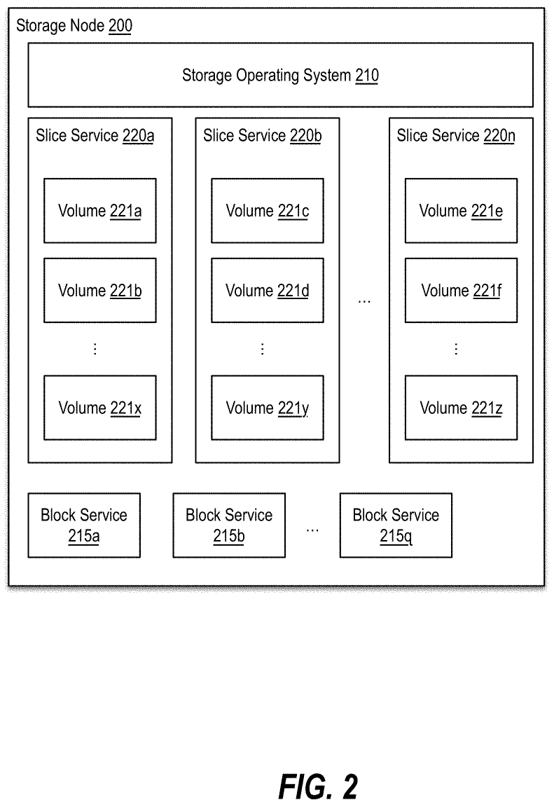

In the embodiments shown in FIG. 1, cluster 135a includes multiple storage nodes 136a-n and an Application Programming Interface (API) 137. In the context of the present example, the multiple storage nodes 136a-n are organized as a cluster and provide a distributed storage architecture to service storage requests issued by one or more clients (not shown) of the cluster. The data served by the storage nodes 136a-n may be distributed across multiple storage units embodied as persistent storage devices, including but not limited to hard disk drives, solid state drives, flash memory systems, or other storage devices. A non-limiting example of a storage node 136 is described in further detail below with reference to FIG. 2.

The API 137 may provide an interface through which the cluster 135a is configured and/or queried by external actors (e.g., the collector 138, the computer system 110, and a cloud-based, centralized monitoring system (e.g., monitoring system 122)). Depending upon the particular implementation, the API 137 may represent a Representational State Transfer (REST)ful API that uses Hypertext Transfer Protocol (HTTP) methods (e.g., GET, POST, PATCH, DELETE, and OPTIONS) to indicate its actions. Depending upon the particular embodiment, the API 137 may provide access to various telemetry data (e.g., time series performance metrics, such as information indicative of block capacity fullness and/or metadata capacity fullness) relating to the cluster 135 or components thereof. In one embodiment, a first API call may be used to obtain information regarding a custom, proprietary, or standardized measure of the block storage capacity usage of a particular storage node 136 or a second API call may be used to obtain information regarding the overall block storage capacity usage of multiple storage nodes 136. As those skilled in the art will appreciate various other types of telemetry data may be made available via the API 137, including, but not limited to a measures of metadata storage capacity usage and/or other performance metrics at various levels (e.g., the cluster level, the storage node level, or the storage node component level).

In various examples described herein, the collector 138 is implemented locally within the same data center in which the cluster 135 resides and periodically polls for time series telemetry data of the cluster 135 via the API 137. Depending upon the particular implementation, the polling may be performed at a predetermined or configurable interval (e.g., X minutes or Y hours). The collector 138 may locally process and/or aggregate the collected time series telemetry data over a period of time (e.g., 24 hours) and locally store time series telemetry data records each containing a performance metric (e.g., information regarding a consumed block capacity), a cluster identifier, and a timestamp (indicative of the time and/or date of performance metric). The collector 138 may also periodically collect information regarding other characteristics or attributes (e.g., information indicative of the block storage capacity) of the monitored distributed storage systems at the same or a different rate. For example, the collector 138 may obtain information regarding a configured, available, and/or used block storage capacity or metadata storage capacity.

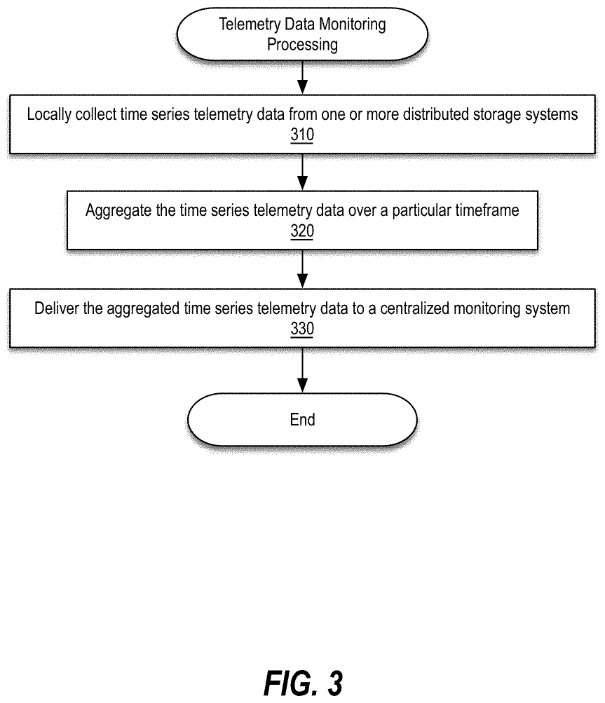

The collector 138 may periodically report the collected time series telemetry data and the other characteristics or attributes to the centralized monitoring system 122 or the centralized monitoring system 122 may request the collected time series telemetry data from the collector 138. Additional details regarding example functionality of the collector 138 are described below with reference to FIG. 3.

In the context of the present example, the cloud 120, which may represent a private or public cloud accessible (e.g., via a web portal) to an administrator associated with a managed service provider and/or administrators of one or more customers of the managed service provider, includes a cloud-based, centralized monitoring system (e.g., monitoring system 112). The monitoring system 122 may periodically receive monitored information, including raw and/or processed time series telemetry data of one or more clusters (e.g., clusters 135a-n) from multiple distributed collectors (e.g., collector 138) operable within respective data centers (e.g., data centers 130a-x) of one or more customers of the managed service provider. Depending upon the particular implementation, the monitored information may be pushed from the collector 138 or pulled from the collector 138 in accordance with a forecasting schedule associated with a forecasting engine 124 or responsive to an event (e.g., a request issued by user 112 to the monitoring system 112).

According to one embodiment, the forecasting engine 124 is operable to train multiple time series forecasting models (e.g., machine-learning (ML) models 125a-y) based on a subset of training data extracted from the time series telemetry data received from the collector 138. In one embodiment, a forecasting approach implemented by the forecasting engine 124 represents a generalized solution to block capacity threshold forecasting for a distributed storage system and utilizes a best-model-candidate approach to account for and forecast various linear and nonlinear trends in block capacity usage for individual distributed storage devices in a field of distributed storage devices.

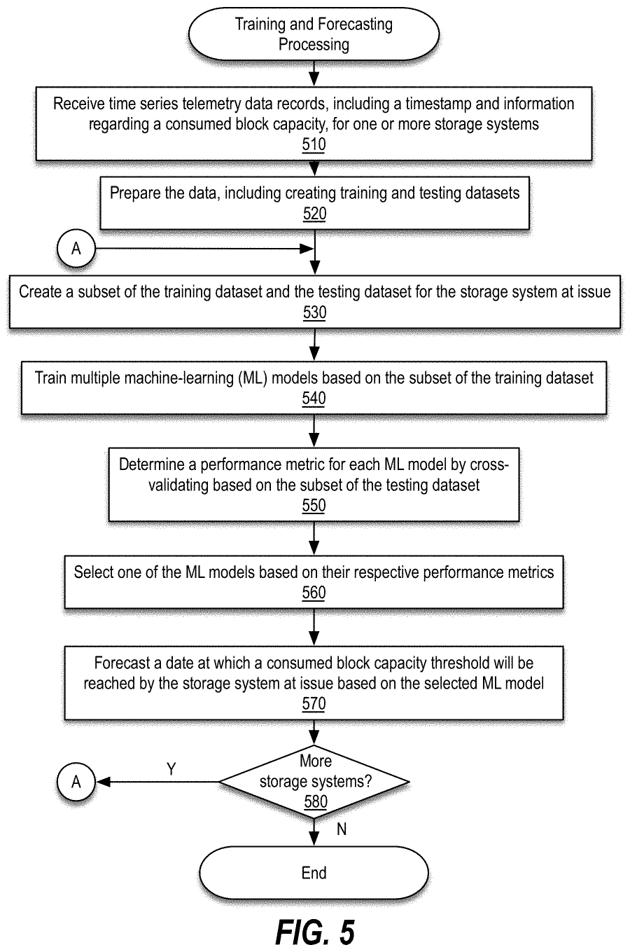

Given a telemetry dataset from a field of distributed storage devices, a forecasting algorithm can account for each individual distributed storage system's used block capacity trend and accurately forecast out to various thresholds, thereby producing forecasted data points for each monitored distributed storage device a time frame (e.g., a date or date range) on or within which or an amount of time until the forecasting algorithm predicts the threshold(s) will be crossed. Additional details regarding example functionality of the forecasting engine 124 are described below with reference to FIG. 5.

In one embodiment, the multiple time series forecasting models may be used to generate a range or confidence interval during which a particular threshold will be reached. In order to have more conservative estimates, an upper bound of the confidence interval may be used to predict the various thresholds.

While for sake of brevity, only a single data center 130a and a single cluster 135a have been described in the context of the present example, it is to be appreciated that multiple clusters owned by or leased by the same or different companies may be monitored in accordance with the methodologies described herein and such clusters may reside in multiple data centers of different types (e.g., enterprise data centers, managed services data centers, or colocation data centers).

### Example Storage Node

FIG. 2 is a block diagram illustrating a storage node 200 in accordance with an embodiment of the present disclosure. Storage node 200 represents a non-limiting example of storage nodes 136a-n. In the context of the present example, storage node 200 includes a storage operating system 210, one or more slice services 220a-n, and one or more block services 215a-q. The storage operating system (OS) 210 may provide access to data stored by the storage node 200 via various protocols (e.g., small computer system interface (SCSI), Internet small computer system interface (ISCSI), fibre channel (FC), common Internet file system (CIFS), network file system (NFS), hypertext transfer protocol (HTTP), web-based distributed authoring and versioning (WebDAV), or a custom protocol. A non-limiting example of the storage OS 210 is NetApp Element Software (e.g., the SolidFire Element OS) based on Linux and designed for SSDs and scale-out architecture with the ability to expand up to 100 storage nodes.

Each slice service 220 may include one or more volumes (e.g., volumes 221a-x, volumes 221c-y, and volumes 221e-z). Client systems (not shown) associated with an enterprise may store data to one or more volumes, retrieve data from one or more volumes, and/or modify data stored on one or more volumes.

The slice services 220a-n and/or the client system may break data into data blocks. Block services 215a-q and slice services 220a-n may maintain mappings between an address of the client system and the eventual physical location of the data block in respective storage media of the storage node 200. In one embodiment, volumes 221 include unique and uniformly random identifiers to facilitate even distribution of a volume's data throughout a cluster (e.g., cluster 135). The slice services 220a-n may store metadata that maps between client systems and block services 215. For example, slice services 220 may map between the client addressing used by the client systems (e.g., file names, object names, block numbers, etc. such as Logical Block Addresses (LBAs)) and block layer addressing (e.g., block identifiers) used in block services 215. Further, block services 215 may map between the block layer addressing (e.g., block identifiers) and the physical location of the data block on one or more storage devices. The blocks may be organized within bins maintained by the block services 215 for storage on physical storage devices (e.g., SSDs).

A bin may be derived from the block ID for storage of a corresponding data block by extracting a predefined number of bits from the block identifiers. In some embodiments, the bin may be divided into buckets or “sublists” by extending the predefined number of bits extracted from the block identifier. A bin identifier may be used to identify a bin within the system. The bin identifier may also be used to identify a particular block service 215a-q and associated storage device (e.g., SSD). A sublist identifier may identify a sublist with the bin, which may be used to facilitate network transfer (or syncing) of data among block services in the event of a failure or crash of the storage node 200. Accordingly, a client can access data using a client address, which is eventually translated into the corresponding unique identifiers that reference the client's data at the storage node 200.

For each volume 221 hosted by a slice service 220, a list of block identifiers may be stored with one block identifier for each logical block on the volume. Each volume may be replicated between one or more slice services 220 and/or storage nodes 200, and the slice services for each volume may be synchronized between each of the slice services hosting that volume. Accordingly, failover protection may be provided in case a slice service 220 fails, such that access to each volume may continue during the failure condition.

The above structure allows storing of data evenly across the cluster of storage devices (e.g., SSDs), which allows for performance metrics to be used to manage load in the cluster. For example, if the cluster is under a load meeting or exceeding a particular threshold, clients can be throttled or locked out of a volume by, for example, the storage OS 210 reducing the amount of read or write data that is being processed by the storage node 200

As noted above, in some embodiments, a collector module (e.g., collector 138) may poll an API (e.g., API 137) of a distributed storage system (e.g., cluster 135) of which the storage node 200 is a part to obtain various telemetry data of the distributed storage system. The telemetry data may represent performance metrics associated with various levels or layers of the cluster or the storage node 200. For example, metrics may be available for individual or groups of storage nodes (e.g., 136a-n), individual or groups of volumes 221, individual or groups of slice services 220, and/or individual or groups of block services 215.

### Telemetry Data Monitoring

FIG. 3 is a flow diagram illustrating an example of a set of operations for telemetry data monitoring in accordance with an embodiment of the present disclosure. In various embodiments described herein, the telemetry data monitoring may involve various aspects being performed by a pipeline of processes distributed across one or more computer systems or modules (e.g., collector 138, monitoring system 122, and forecasting engine 124). In alternative embodiments, aspects of the pipeline may be performed by more or fewer computer systems or modules.

At block 410, time series telemetry data is locally collected from one of more distributed storage systems. For example, a collector (e.g., collector 138) operable within the same data center (e.g., data center 130) in which the distributed storage system (e.g., cluster 135a) resides may periodically poll an API (e.g., API 137) of the cluster. In one embodiment, the telemetry data collection (polling) interval may be a predefined or configurable value that may be controlled by an administrative console (e.g., computer system 110). For example, a first API method of the distributed storage system may provide information regarding block capacity fullness, for example, in terms of a number of bytes of block capacity of the distributed storage system that is currently used. In some embodiments, the first API method may be called on the order of every 60 minutes or so. As the total block storage capacity of the distributed storage system may change over time, for example, as a result of storage nodes (e.g., storage nodes 136a-n) being added or removed from the distributed storage system, in some embodiments, a second API method of the distributed storage system may provide information regarding a total number of bytes of block storage capacity of the distributed storage system. The second API may be called on the order of every 5 minutes or so. In other embodiments, a single API method may provide both information regarding block storage usage and the total configured amount of block storage capacity of the distributed storage system at issue.

At block 420, the time series telemetry data is aggregated over a particular timeframe. A minimum number of observations may be useful for obtaining accurate forecasting results and this minimum number may vary from distributed storage system to distributed storage system and from model to model of the time series forecasting models (e.g., ML models 125a-y). In one embodiment, the aggregation timeframe may be configured so as to collect a number (e.g., at least 100) of observations regarding used capacity (e.g., used block storage capacity) sufficient to produce desired forecasting accuracy for the worst-case combination of a particular distributed storage system and a particular time series forecasting model.

At block 430, the aggregated telemetry data is delivered to a centralized monitoring system. According to one embodiment, in order to facilitate remote monitoring of multiple managed distributed storage systems, a cloud-based monitoring system (e.g., monitoring system 122) periodically pulls the time series telemetry data aggregated by the collector to provide a centralized data store from which the multiple managed distributed storage systems may be monitored remotely, individually or in various combinations. Alternatively, the collectors may periodically push the aggregated time series telemetry data to the cloud-based monitoring system or the time series telemetry data may be pushed or pulled responsive to an event (e.g., a request by an administrator).

In one embodiment, time series telemetry data may be gathered constantly by polling the API, resulting in near-real-time updates to the monitoring system. Depending upon the particular implementation, different types of telemetry data may be polled and aggregated at different intervals.

As those skilled in the art will appreciate, there will typically be periods of time for a particular distributed storage system or for multiple distributed storage systems of a field of distributed storage systems over which block capacity trends do not fit a linear trend due to non-linear seasonal/business usage patterns. Table 1 (below) provides an example of nineteen time series telemetry data records collected from a distributed storage system over the course of nineteen days.

TABLE 1
Example Time Series
Telemetry Data

| | | Used Block |
|---|---|---|
| Cluster ID | Timestamp | Capacity |
| 11111111 | 01/01/2020 | 67304957494 |
| 11111111 | 01/02/2020 | 67307623494 |
| 11111111 | 01/03/2020 | 67307956123 |
| 11111111 | 01/04/2020 | 67307950087 |
| 11111111 | 01/05/2020 | 67308659932 |
| 11111111 | 01/06/2020 | 67308657414 |
| 11111111 | 01/07/2020 | 67308667210 |
| 11111111 | 01/08/2020 | 67308671239 |
| 11111111 | 01/09/2020 | 67308679932 |
| 11111111 | 01/10/2020 | 67308684478 |
| 11111111 | 01/11/2020 | 67308700730 |
| 11111111 | 01/12/2020 | 67428801099 |
| 11111111 | 01/13/2020 | 67589370164 |
| 11111111 | 01/14/2020 | 67301954727 |
| 11111111 | 01/15/2020 | 67239890032 |
| 11111111 | 01/16/2020 | 67239940303 |
| 11111111 | 01/17/2020 | 67249872402 |
| 11111111 | 01/18/2020 | 67304868504 |
| 11111111 | 01/19/2020 | 67346639022 |

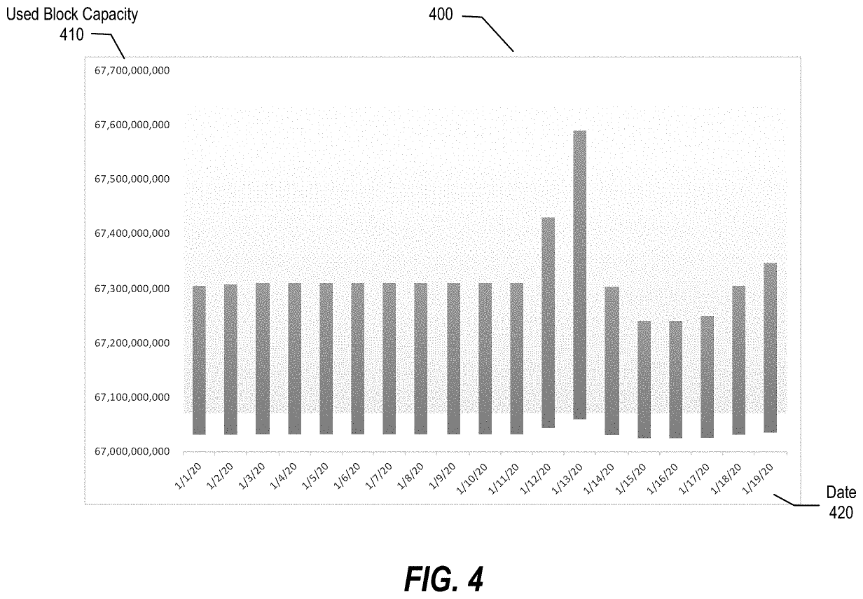

FIG. 4 is a bar chart 400 illustrating used block capacity 410 over time for a distributed storage system. In the context of the present example, the bar chart 400 represents the used block capacity 410 observations by date 420 for the time series telemetry data records shown in Table 1. Even in this relatively small sample set for a single distributed storage system (e.g., one of clusters 135a-n) having cluster identifier (ID) 11111111, it can be readily seen that used block capacity 410 does not follow a linear trend.

While in the context of the present example, a limited number of time series telemetry data records at a particular interval (e.g., one day) are illustrated for a single distributed storage system, those skilled in the art will appreciate more time series telemetry data records may be collected, the collected time series telemetry data records may relate to a larger set of distributed storage systems (e.g., a group of distributed storage systems used by a particular tenant, a group of distributed storage systems owned by a particular customer of the vendor of the distributed storage systems, or a group of distributed storage systems spanning multiple tenants or customers).

### Training and Forecasting

FIG. 5 is a flow diagram illustrating an example of a set of operations for training and forecasting processing in accordance with an embodiment of the present disclosure. Depending upon the particular implementation, some portion or all of the training and forecasting processing may be performed by one or more processes distributed across one or more computer systems or modules (e.g., collector 138, monitoring system 122, and forecasting engine 124). In alternative embodiments, aspects of the pipeline may be performed by more or fewer computer systems or modules. In one embodiment, multiple time series forecasting models are trained for each distributed storage system of a set of one or more distributed storage systems based on a set of training data for the distributed storage system. The “best” model for the distributed storage system may be selected for the distributed storage system based on a performance metric calculated for each of the multiple time series forecasting models. For example, the best performing model of multiple trained ML models for a particular monitored distributed storage system may be selected based on the trained ML model having the least root mean square error.

The selected model may then be used to accurately forecast how long until (e.g., one or more dates at which or date ranges within which) various block capacity fullness thresholds are expected to be crossed. In this manner, forecasts may be efficiently performed for multiple distributed storage systems while also accounting for various linear and nonlinear trends in block capacity usage for the individual distributed storage systems which may be supporting a variety of different types and numbers of workloads.

At block 510, time series telemetry data records, containing at least a timestamp and information regarding a consumed block capacity, are received for one or more monitored distributed storage systems. In one embodiment, a centralized monitoring system (e.g., monitoring system 122) may collect time series telemetry data from a field of distributed storage systems (e.g., clusters 135a-n) and periodically request a forecast to be performed by a forecasting engine (e.g., forecasting engine 124) based on a sliding window of historical time series telemetry data records.

At block 520, the time series telemetry data may be cleaned or otherwise prepared to facilitate downstream use as training/testing data for the multiple time series forecasting models. For example, empty time series telemetry data records may be inserted where there are gaps (e.g., missing data points). Such gaps may result from a temporary loss of communication with a monitored distributed storage system, for example, due to one or more nodes of the distributed storage system being taken offline, network issues or the like. As described further below, these placeholder time series telemetry data records may later be used for imputation.

According to one embodiment, separate temporally ordered training and testing datasets may be created. For example, the received time series telemetry data records, may be randomly assigned to the training and testing datasets based on a predefined or configurable proportion. The training and test datasets may be persisted in a data store, for example, to facilitate reproducibility and/or debugging.

In addition, a minimum time series length may be enforced to promote model accuracy. Those skilled in the art appreciate splitting data into testing and training datasets depends on the total number of samples and the model at issue. Some models need more data to train upon than others. In one embodiment, a predetermined or configurable minimum threshold of time series telemetry data records may be selected to accommodate the model of the multiple models employed having the greatest need for training data. As such, any distributed storage systems having fewer than a predetermined or configurable threshold of time series telemetry data records may be removed from the current cycle of training and forecasting processing.

In the context of the present example, blocks 530 to block 570 represent a set of steps that are performed for each of one or more distributed storage systems for which time series telemetry data has been collected.

At block 530, a subset of the training dataset and the testing dataset for a distributed storage system at issue are created. According to one embodiment, labeled arrays are created out of the time series telemetry data records and their timestamps. The subset of the training dataset and the subset of the testing dataset for a particular distributed storage system may be extracted from the training and testing datasets created in block 520 based on a cluster ID assigned to the particular distributed storage system. At this point, missing data values may be imputed for the placeholder time series telemetry data records previously inserted. For example, the missing data values may be estimated based on nearby values.

At block 540, multiple time series forecasting models (e.g., ML models 125a-y) are trained based on the subset of the training dataset. Non-limiting examples of the types of time series forecasting models that may be among the multiple time series forecasting models include:
Simple linear regression (SLR),
Autoregressive Integrated Moving Average (ARIMA),
Generalized additive model (GAM),
Autoregression (AR),
Moving Average (MA),
Autoregressive Moving Average (ARMA),
Seasonal Autoregressive Integrated Moving-Average (SARIMA),
Seasonal Autoregressive Integrated Moving-Average with Exogenous Regressors (SARIMAX),
Vector Autoregression (VAR),
Vector Autoregression Moving-Average (VARMA),
Vector Autoregression Moving-Average with Exogenous Regressors (VARMAX).
Simple Exponential Smoothing (SES),
Holt Winter's Exponential Smoothing (HWES),
Recurrent Neural Network, and
XGBoost (using a sliding window representation).

At block 550, a performance metric is determined for each ML model by performing cross-validation based on the subset of the testing dataset for the particular distributed storage system at issue. As those skilled in the art will appreciate, there are a variety of types of cross-validation including, leave-p-out cross-validation, leave-one-out cross-validation, k-fold cross-validation, holdout method, and repeated random sub-sampling validation. There are also a number of potential performance metrics that may be used to evaluate the performance of the models, including, but not limited to Root Mean Squared Error (RMSE), R-Squared (the proportion of variation in the outcome that is explained by the predictor variables), Mean Absolute Error, and Mean Absolute Percentage Error.

At block 560, one of the ML models is selected based on their respective performance metrics. In one embodiment, the model having the optimal performance metric is selected (e.g., the ML model having the smallest RMSE). That is, in some examples, “optimal” is defined by the performance metric. Via the process of cross-validation this metric is provided as an output. Then, these output performance metrics from each ML model may be compared across the cross-validation of each ML model and the “optimal” model defined by the given performance metric may be selected. For example, if the given performance metric were root mean squared error, the ML model having the smallest value of root mean squared error would be selected. In alternative embodiments, best-model-candidate selection approach may involve mapping workloads to the best models for that given workload or by selecting a subset of the multiple models with the top set of one or more performance metrics. In any event, at this point, the selected time series forecasting model(s) may be used to forecast out to one or more capacity thresholds of interest.

At block 570, a date may be forecasted at which a consumed block capacity threshold will be reached by the distributed storage system at issue based on the selected ML model. In some embodiments, dates may be forecasted for multiple consumed block capacity thresholds, for example, to support generation of events of various levels of severity and potential corresponding types of alarms or notifications. Alternatively or additionally, an amount of time until one or more predetermined or configurable block capacity fullness thresholds or a window of time (e.g., a date range or a time range) during which such thresholds are predicted to be crossed may be determined. In some embodiments, a confidence associated with the prediction/forecast may also be determined and output by the selected model.

In some examples, model parameters, forecasts, performance metrics, and other data regarding timing and frequency of usage of the multiple ML models over time may be stored. This information may be used to select a subset of the universe of available ML models (e.g., those listed above in connection with the description of block 540) that are to be used in connection with the above-described training and forecasting processing. For example, a least recently used (LRU) or least frequently used (LFU) algorithm may be used to at least temporarily discontinue use of one or more ML models that are not being selected with sufficient frequency within the field of monitored distributed storage systems. Those of the ML models that are temporarily sidelined may be replaced with other ML models from the universe of available ML models.

In some embodiments, events of various levels of severity (e.g., warning, error, and critical) may be generated by the forecasting engine based on event configurations established by an administrator (e.g., user 112) of the distributed storage system at issue or established as defaults for the distributed storage system, for example, based on the block capacity of the distributed storage system. Depending upon the particular implementation, the administrator may be provided with the ability to configure different types of alarms, notifications (e.g., logged, presented via a user interface, and/or delivered out-of-band via email or text message), and/or automated actions (e.g., throttling of input/output requests processed by a distributed storage system) to be triggered responsive to occurrence of various types of events. For example, a warning event may be generated when the date forecasted for crossing an 80% block capacity fullness threshold is predicted to occur within the next year, an error event may be generated when the date forecasted for crossing a 90% block capacity fullness threshold is predicted to occur within the next month, and a critical event may be triggered responsive to the date forecasted for crossing a 90% block capacity fullness threshold being predicted to be imminent (e.g., within a matter of days).

### Example Computer System

Embodiments of the present disclosure include various steps, which have been described above. The steps may be performed by hardware components or may be embodied in machine-executable instructions, which may be used to cause a processing resource (e.g., a general-purpose or special-purpose processor) programmed with the instructions to perform the steps. Alternatively, depending upon the particular implementation, various steps may be performed by a combination of hardware, software, firmware and/or by human operators.

Embodiments of the present disclosure may be provided as a computer program product, which may include a non-transitory machine-readable storage medium embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more non-transitory machine-readable storage media containing the code according to embodiments of the present disclosure with appropriate special purpose or standard computer hardware to execute the code contained therein. An apparatus for practicing various embodiments of the present disclosure may involve one or more computers (e.g., physical and/or virtual servers) (or one or more processors within a single computer) and storage systems containing or having network access to computer program(s) coded in accordance with various methods described herein, and the method steps associated with embodiments of the present disclosure may be accomplished by modules, routines, subroutines, or subparts of a computer program product.

FIG. 8 is a block diagram that illustrates a computer system 800 in which or with which an embodiment of the present disclosure may be implemented. Computer system 800 may be representative of all or a portion of the computing resources associated with a storage node (e.g., storage node 136), a collector (e.g., collector 138), a monitoring system (e.g., monitoring system 122), a forecasting engine (e.g., forecasting engine 124), or an administrative work station (e.g., computer system 110). Notably, components of computer system 800 described herein are meant only to exemplify various possibilities. In no way should example computer system 800 limit the scope of the present disclosure. In the context of the present example, computer system 800 includes a bus 802 or other communication mechanism for communicating information, and a processing resource (e.g., a hardware processor 804) coupled with bus 802 for processing information. Hardware processor 804 may be, for example, a general purpose microprocessor.

Computer system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Such instructions, when stored in non-transitory storage media accessible to processor 804, render computer system 800 into a special-purpose machine that is customized to perform the operations specified in the instructions.

Computer system 800 further includes a read only memory (ROM) 808 or other static storage device coupled to bus 802 for storing static information and instructions for processor 804. A storage device 810, e.g., a magnetic disk, optical disk or flash disk (made of flash memory chips), is provided and coupled to bus 802 for storing information and instructions.

Computer system 800 may be coupled via bus 802 to a display 812, e.g., a cathode ray tube (CRT), Liquid Crystal Display (LCD), Organic Light-Emitting Diode Display (OLED), Digital Light Processing Display (DLP) or the like, for displaying information to a computer user. An input device 814, including alphanumeric and other keys, is coupled to bus 802 for communicating information and command selections to processor 804. Another type of user input device is cursor control 816, such as a mouse, a trackball, a trackpad, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

Removable storage media 840 can be any kind of external storage media, including, but not limited to, hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM), USB flash drives and the like.

Computer system 800 may implement the techniques described herein using customized hard-wired logic, one or more ASICs or FPGAs, firmware or program logic which in combination with the computer system causes or programs computer system 800 to be a special-purpose machine. According to one embodiment, the techniques herein are performed by computer system 800 in response to processor 804 executing one or more sequences of one or more instructions contained in main memory 806. Such instructions may be read into main memory 806 from another storage medium, such as storage device 810. Execution of the sequences of instructions contained in main memory 806 causes processor 804 to perform the process steps described herein. In alternative embodiments, hard-wired circuitry may be used in place of or in combination with software instructions.

The term “storage media” as used herein refers to any non-transitory media that store data or instructions that cause a machine to operation in a specific fashion. Such storage media may comprise non-volatile media or volatile media. Non-volatile media includes, for example, optical, magnetic or flash disks, such as storage device 810. Volatile media includes dynamic memory, such as main memory 806. Common forms of storage media include, for example, a flexible disk, a hard disk, a solid state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 802. Transmission media can also take the form of acoustic or light waves, such as those generated during radio-wave and infra-red data communications.

Various forms of media may be involved in carrying one or more sequences of one or more instructions to processor 804 for execution. For example, the instructions may initially be carried on a magnetic disk or solid state drive of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world wide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are example forms of transmission media.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818. The received code may be executed by processor 804 as it is received, or stored in storage device 810, or other non-volatile storage for later execution.

What is claimed is:

1. A method performed by a processing resource of a computer system, the method comprising:
receiving a plurality of time series telemetry data records collected from a plurality of distributed storage systems,
wherein each time series telemetry data record of the plurality of time series telemetry data records includes a timestamp and information regarding a consumed block capacity;
splitting the plurality of time series telemetry data records into a training dataset and a testing dataset; and
for each distributed storage system of the plurality of distributed storage systems:
creating a subset of the training dataset and a subset of the testing dataset for the distributed storage system;
training a plurality of machine-learning models based on the subset of the training dataset;
selecting a trained machine-learning model of the plurality of trained machine-learning models based on a performance metric determined for each trained machine-learning model of the plurality of trained machine-learning models by cross-validating the plurality of trained machine-learning models using the subset of the testing dataset; and
forecasting an amount of time until a consumed block capacity threshold will be reached by the distributed storage system based on the selected trained machine-learning model.

2. The method of claim 1, wherein the plurality of machine-learning models include one or more of:
a simple linear regression algorithm;
an autoregressive integrated moving average algorithm; and
a generalized additive model.

3. The method of claim 1, wherein the performance metric comprises a root mean squared error.

4. The method of claim 1, wherein each distributed storage system of the plurality of distributed storage systems has a unique identifier (ID), wherein each time series telemetry data record of the plurality of time series telemetry data records further includes the unique ID of one of the distributed storage systems of the plurality of distributed storage systems, and wherein said creating the subset of the training dataset and the subset of the testing dataset for the storage system is based on the unique ID of the distributed storage system.

5. The method of claim 1, further comprising imputing information regarding the consumed block capacity for missing data records within the subset of the training dataset and the subset of the testing dataset.

6. The method of claim 1, wherein the information regarding a consumed block capacity comprises a number of bytes of block capacity of the distributed storage system in use.

7. The method of claim 1, wherein said splitting the plurality of time series telemetry data records into a training dataset and a testing dataset is based on a predefined or configurable proportion.

8. A system comprising:
a processing resource; and
a non-transitory computer-readable medium, coupled to the processing resource, having stored therein instructions that when executed by the processing resource cause the system to:
receive a plurality of time series telemetry data records collected from a plurality of distributed storage systems, wherein each time series telemetry data record of the plurality of time series telemetry data records includes a timestamp and information regarding a consumed block capacity;
split the plurality of time series telemetry data records into a training dataset and a testing dataset; and
for each distributed storage system of the plurality of distributed storage systems:
creating a subset of the training dataset for the distributed storage system; and
training a plurality of time series forecasting models to forecast an amount of time until a consumed block capacity threshold will be reached by the distributed storage system based on the subset of the training dataset.

9. The system of claim 8, wherein execution of the instructions by the processing resource further cause the system to for each distributed storage system of the plurality of distributed storage systems:
create a subset of the testing dataset for the distributed storage system;
determine a performance metric for each trained time series forecasting model of the plurality of trained time series forecasting models by cross-validating the plurality of trained time series forecasting models using the subset of the testing dataset; and
select a trained time series forecasting model of the plurality of trained time series forecasting models based on their respective performance metrics; and
forecast the amount of time until the consumed block capacity threshold will be reached by the distributed storage system based on the selected trained time series forecasting model.

10. The system of claim 8, wherein the plurality of time series forecasting models include one or more of:
a simple linear regression algorithm;
an autoregressive integrated moving average algorithm; and
a generalized additive model.

11. The system of claim 9, wherein the performance metric comprises a root mean squared error, R-Squared, a Mean Absolute Error, or a Mean Absolute Percentage Error.

12. The system of claim 8, wherein the information regarding the consumed block capacity comprises a number of bytes of block capacity of the distributed storage system in use.

13. The system of claim 8, wherein execution of the instructions by the processing resource further cause the system to impute information regarding the consumed block capacity for missing data records within the subset of the training dataset and the subset of the testing dataset.

14. A non-transitory computer-readable storage medium embodying a set of instructions, which when executed by a processing resource cause the processing resource to:
determine a performance metric for each trained machine-learning model of a plurality of trained machine-learning models for each of a plurality of distributed storage systems,
wherein the plurality of trained machine-learning models are trained based on a plurality of time series telemetry data records collected from the plurality of distributed storage systems, and
wherein each time series telemetry data record of the plurality of time series telemetry data records includes a timestamp and information regarding a consumed block capacity;
select a trained machine-learning model of the plurality of trained machine-learning models based on their respective performance metrics; and
forecast an amount of time until a consumed block capacity threshold will be reached by the distributed storage system based on the selected trained machine-learning model.

15. The non-transitory computer-readable storage medium of claim 14, wherein the set of instructions further cause the processing resource to split the plurality of time series telemetry data records into a training dataset and a testing dataset, and wherein the performance metric for a particular trained machine-learning model of the plurality of trained machine-learning models is determined by cross-validating the plurality of trained machine-learning models using a subset of the testing dataset for the particular trained machine-learning model.

16. The non-transitory computer-readable storage medium of claim 14, wherein the set of instructions further causes the processing resource to impose a minimum threshold on a number of the plurality of time series telemetry data records.

17. The non-transitory computer-readable storage medium of claim 14, wherein the plurality of machine-learning models include one or more of:
a simple linear regression algorithm;
an autoregressive integrated moving average algorithm; and
a generalized additive model.

18. The non-transitory computer-readable storage medium of claim 14, wherein the performance metric comprises a root mean squared error, R-Squared, a Mean Absolute Error, or a Mean Absolute Percentage Error.

19. The non-transitory computer-readable storage medium of claim 14, wherein the information regarding a consumed block capacity comprises a number of bytes of block storage of the distributed storage system that are in use.

20. The non-transitory computer-readable storage medium of claim 14, wherein the set of instructions further cause the processing resource to impute information regarding the consumed block capacity for missing data records within the plurality of time series telemetry data records.
